(19) United States
(12) Patent Application Publication
(10) Pub. No.: US 2010/0264591 A1
(43) Pub. Date: Oct. 21, 2010

(54) NAPKIN WITH PRINTED IMAGE PROMOTING INTERACTIVITY

(76) Inventors: Phillip Lacoi Hutchison, Cincinnati, OH (US); Cathy Marie Sanders, Cleves, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/425,669

(22) Filed: Apr. 17, 2009

(51) Int. Cl. A63F 3/00; A47G 11/00; B32B 3/10; B32B 3/04; A63F 9/08

(52) U.S. Cl. 273/287; 428/211.1; 428/195.1; 428/130; 428/124; 273/153 R

(57) ABSTRACT

A paper napkin having an image extending across more than one quadrant thereof motivates a user to interact with the napkin. A portion of the image is visible when the napkin is in a first folded condition, which portion of the image appears to be a complete image. When the napkin is unfolded from the first condition to a second condition, one or more further portions of the image is revealed. The image may include indicia to prompt the user to write or draw on the napkin.

### FIELD OF THE INVENTION

This disclosure relates generally to printed paper goods. This disclosure more particularly relates to foldable paper napkins having images printed thereon that promote user interaction.

### BACKGROUND OF THE INVENTION

Printed paper napkins are commonly used in a variety of settings, such as fast-food restaurants, cafeterias, in the home, school lunchrooms, kitchens, picnics, barbecues, sporting events, and birthday parties, to name just a few. The paper napkin has the capacity to be a particularly useful object in teaching proper table etiquette to children. A napkin that can capture a child's attention, and which that child is encouraged to unfold, can advantageously occupy the child while waiting for food to be served. The napkin will also more likely be properly placed on the child's lap for use during the meal. While printing images on paper napkins is known, the use of imagery on napkins in a manner that promotes unfolding of the napkin and prompts a user to write or draw on the napkin surface and provides the ability to correlate a design or image to an intended use is not adequately addressed by existing paper napkins.

### SUMMARY OF THE INVENTION

The present disclosure presents various embodiments of paper napkins having imagery that promotes interactivity with the surface of the napkin. In at least several of the embodiments, the interactivity is in the form of unfolding the napkin to reveal further visible portions of an image that, together with the portion of the image on the region of the napkin visible in the initially-folded state of the napkin, forms a larger image.

In a first exemplary, but non-limiting, embodiment, a rectangular paper napkin has an image printed thereon in the form of intersecting diagonal lines extending from opposite corners of the napkin, forming an “X” shape. The rectangular paper napkin may be folded at least twice, thereby dividing the napkin into four quadrants. Each of the four quadrants has a diagonal stripe thereon. The napkin may additionally be folded diagonally, i.e. into eighths, along the diagonal stripe of one of the quadrants. The resulting triangular-shaped visible region of the napkin has a diagonal line segment extending along its hypotenuse, formed by the visible portion of the intersecting diagonal lines printed on the napkin. This diagonal line on the visible region of the napkin appears to be a complete image. However, when the napkin is unfolded one time, from the triangular shape to a square shape, it can be seen that the width of the diagonal line has increased, e.g., doubled. That an image on one visible surface of the napkin, which appeared to be a complete image, formed a part of a larger image when the napkin was unfolded a first time is found to generate a sufficient level of curiosity to encourage the user to unfold the napkin yet again. In doing so, the user will see that the diagonal lines of two adjacent quadrants of the paper napkin meet, forming a “V” shape. This progressively-growing image encourages the user to open the napkin yet again, revealing the full image of the intersecting diagonal lines extending from opposite corners of the napkin, forming an “X” shape.

In a second exemplary, but non-limiting, embodiment, a rectangular paper napkin includes an image disposed proximate to the center of the napkin. When folded twice, forming four quadrants, the visible quadrant of the napkin has an image of a circular segment in a corner thereof. The circular segment appears to be a complete image. However, when the napkin is unfolded one time, it can be seen that the image of the circular segment forms part of a larger image, that of a semicircle. This apparent growth of the image encourages the user to unfold the napkin again, ultimately revealing the full image located at the center of the napkin.

In third and fourth exemplary, but non-limiting, embodiments, the rectangular paper napkin may include means for encouraging interaction not only in the form of motivating a user to unfold the napkin, but also in the form of prompting the user to write or draw on the surface of the napkin. This can provide the napkin with a communicative or entertainment functionality. More specifically, the image printed on the paper napkin of these embodiments may include indicium or indicia that can promote writing on the napkin. By way of non-limiting example only, the indicium or indicia may be in the form of so-called “thought bubbles” extending from cartoon characters' heads, “speech balloons” extending from cartoon characters' mouths, or blank squares of a game board, such as a tic-tac-toe board. Consistent with the other embodiments of the present disclosure, the portion of the image visible on a first portion of the paper napkin when in a folded condition may appear to be a complete image, but may form part of a larger image when the napkin is completely unfolded. For instance, the portion of the image visible on one quadrant of a rectangular paper napkin when folded into quarters may be that of a tic-tac-toe board. However, when completely unfolded, the full image may be that of a larger game board, such as an image of a plurality of tic-tac-toe boards, a Sudoku game board (Sudoku is a generic name for a type of puzzle having, for example, a grid of squares divided into nine 3-by-3 squares, some of which already contain a number, with the goal being to fill the remaining squares with numerals 1 thru 9 without repeating any digit along a horizontal line, a vertical line, or within a 3-by-3 square), or a checker/chess board.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 is a plan view of an exemplary paper napkin including an image printed thereon of a first embodiment of the present disclosure, with broken lines indicating creases along which the napkin may be folded;

FIG. 2 is a plan view of the paper napkin illustrated in FIG. 1, folded along a longitudinal crease or MD fold of the napkin;

FIG. 3 is a plan view of the paper napkin illustrated in FIG. 1, folded twice such that only one quadrant of the paper napkin is visible;

FIG. 4 is a plan view of the paper napkin illustrated in FIG. 1, diagonally folded from the condition illustrated in FIG. 3 into a triangular shape;

FIG. 5 is a plan view of an alternative embodiment of and exemplary paper napkin including an image printed thereon of a second embodiment of the present disclosure, with broken lines indicating creases along which the napkin may be folded;

FIG. 6 is a plan view of the paper napkin illustrated in FIG. 5, folded along a longitudinal crease or MD fold of the napkin;

FIG. 7 is a plan view of the paper napkin illustrated in FIG. 5, folded twice such that only one quadrant of the paper napkin is visible;

FIG. 8 is a plan view of another alternative embodiment of and exemplary paper napkin including an image printed thereon of a third embodiment of the present disclosure, with broken lines indicating creases along which the napkin may be folded;

FIG. 9 is a plan view of the paper napkin illustrated in FIG. 8, folded twice such that only one quadrant of the paper napkin is visible;

FIG. 10 is a plan view similar to FIG. 9, and illustrating handwriting drawn on a visible portion of the image on the paper napkin;

FIG. 11 is a plan view of a paper napkin including an image printed thereon of a fourth embodiment of the present disclosure;

FIG. 12 is a plan view of the paper napkin illustrated in FIG. 1, folded twice such that only one quadrant of the paper napkin is visible;

FIG. 13 is a plan view of the paper napkin illustrated in FIG. 12, which has been folded first along the MD fold and next along a CD fold, unfolded one time from the condition illustrated in FIG. 12; and

FIG. 14 is a plan view of the paper napkin illustrated in FIG. 12, which has been folded first along a CD fold and next along the MD fold, unfolded one time from the condition illustrated in FIG. 12.

### DETAILED DESCRIPTION OF THE INVENTION

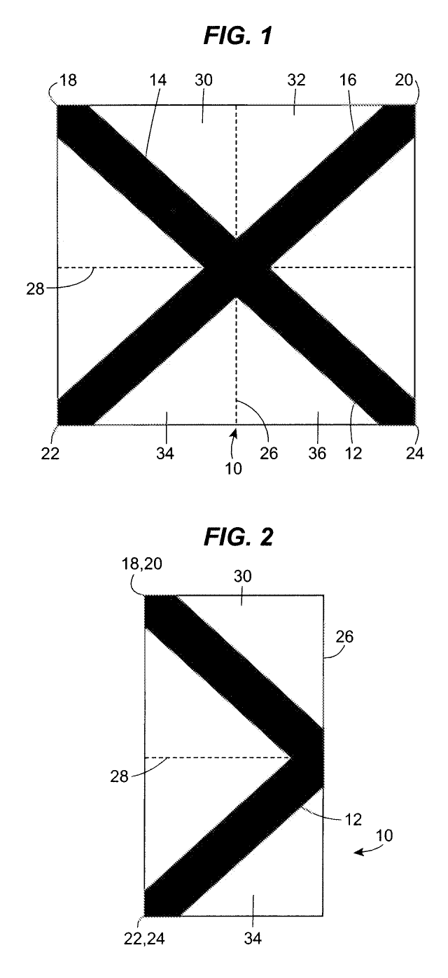

With reference to FIGS. 1-4, a paper napkin 10 of a first embodiment of the present disclosure includes an image 12 disposed thereon. In this embodiment, the image may take the form of a pair of intersecting diagonal lines 14, 16 extending between diagonally opposite corners 18, 24 and 20, 22, respectively, of the napkin 10, forming an “X”-shape. The napkin 10 may include a longitudinal crease along which the napkin 10 is to be folded. In mass-produced, machine-folded paper napkins, this longitudinal crease is formed in the direction of travel of a web material through any manufacturing equipment. This is known in the art, and is referred to hereinafter, as the machine direction fold, or simply MD fold 26. The napkin 10 may further include a crease running perpendicular and co-planar to the longitudinal crease or MD fold 26. This is known in the art, and is referred to hereinafter, as the cross-machine direction fold or CD fold 28. The MD fold 26 and the CD fold 28 preferably divide the napkin 10 into four contiguous quadrants 30, 32, 34, 36.

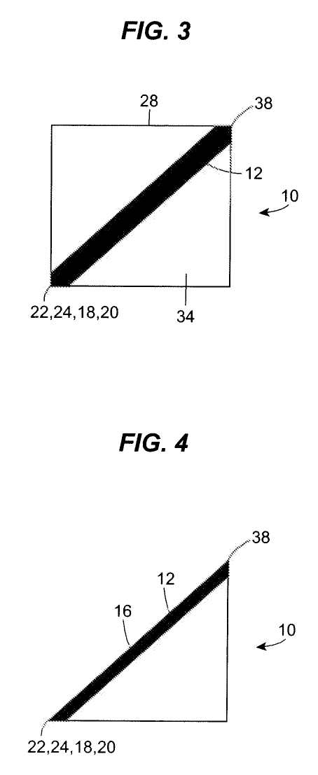

As illustrated in FIG. 2, when the napkin 10 is folded along the MD fold 26, only half of the image 12 is visible, with the image 12 appearing as a “V”-shape. As further illustrated in FIG. 3, when the napkin 10 is folded a second time, along the CD fold 28, with only one of the quadrants 34 visible from a position above the napkin 10, the image 12 appears as only a diagonal line. This is the condition into which the napkin 10 is preferably folded when stacked and packaged for shipment and retail sale.

As illustrated in FIG. 4, when the paper napkin 10 can then be folded from the condition illustrated in FIG. 3, along a diagonal line extending from an intersection 38 of the MD fold 26 and the CD fold 28 to the stacked corners 18, 20, 22, 24 of the paper napkin 10, into a triangular shape, the resulting triangular-shaped visible region of the napkin has a diagonal line segment extending along its hypotenuse, formed by the visible portion of one of the intersecting diagonal lines 16 printed on the napkin. Preferably, this diagonal line segment on the visible region of the napkin appears to be a complete image in the form of a stripe along one edge of the triangle.

In this first embodiment, the triangular shape is preferably an initial condition of the napkin 10, such as when presented to the user as part of his or her table setting. When the user unfolds the paper napkin 10 from its initial condition as illustrated in FIG. 4, to a second condition as illustrated in FIG. 3, the user sees that the diagonal line has increased in width. The diagonal line visible in FIG. 3 appears to be a complete image. However, the surprise effect on the user when seeing that the diagonal line has increased in width upon unfolding the napkin from the initial condition to a second condition tempts the user to unfold the napkin 10 again, upon which the diagonal line becomes a “V”-shaped image, as illustrated in FIG. 2. The continued satisfaction of seeing the image change from a diagonal line to a “V”-shape encourages the user to continue to unfold the napkin 10 yet again, revealing the full “X”-shaped image 12 of the intersecting diagonal lines 14, 16.

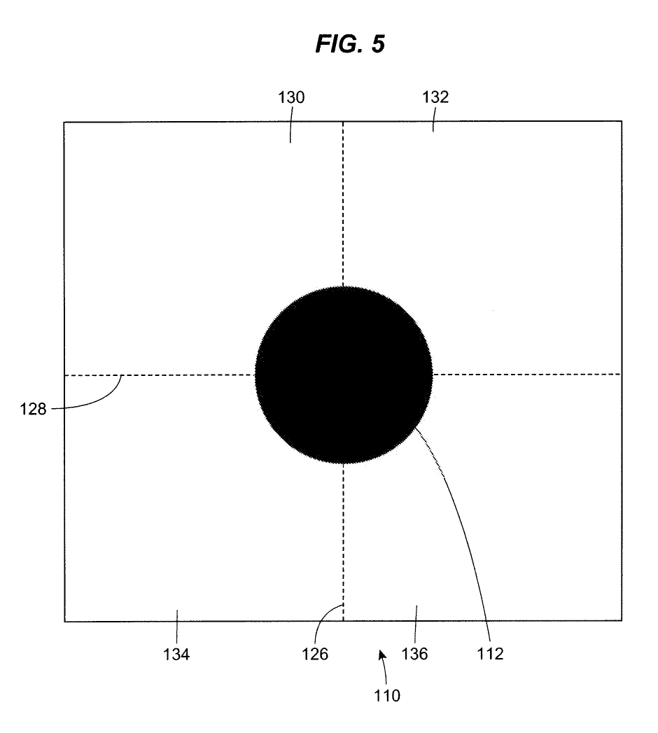

Turning now to FIGS. 5-7, an exemplary, but non-limiting, paper napkin 110 of a second embodiment of the present disclosure includes an image 112 that, by way of example only, may be in the shape of a circle. It should be realized that image 112 may be any image suitable for use with the present invention. Suitable images may include an image 112 that is symmetric or asymmetric about any of MD fold 126, CD fold 128, and/or intersection 138. The napkin 110 may include an MD fold 126 and a CD fold 128. The image 112 is preferably located such that its center is positioned at the intersection 138 of the MD fold 126 and the CD fold 128, with at least a portion of the image 112 extending onto each of four contiguous quadrants 130, 132, 134, 136 of the napkin 110 into which the napkin 110 is divided by the MD fold 126 and the CD fold 128.

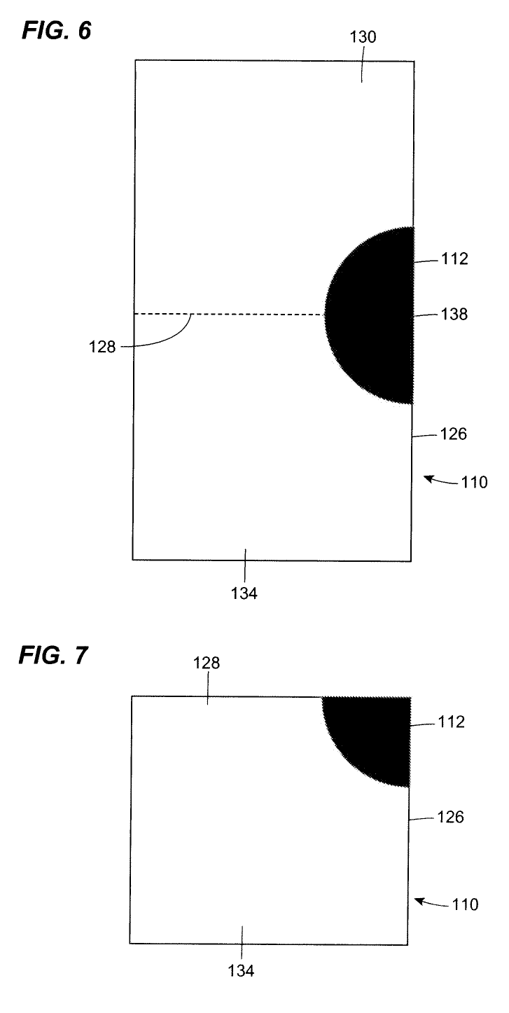

As illustrated in FIG. 7, when the napkin 110 is folded along the MD fold 126, and folded again along the CD fold 128 (or vice versa), such that only one of the quadrants 134 is visible, the portion of the image 112 which is visible on the quadrant 134 appears to be a complete image, in the form of a circular wedge. To the amusement of the user, when the user unfolds the napkin 110 from a first condition, as illustrated in FIG. 7, to a second condition, as illustrated in FIG. 6, a portion of the image extending onto a second quadrant 130 also becomes visible. The portion of the image 112 provided on the quadrant 130 cooperates with the portion of the image provided on the quadrant 134, appearing to be a complete image, in this case in the form of a semicircle. It is recognized that the image 112 may include, by way of example only, a plurality of lines extending radially outwardly from a perimeter of the circle, in the form of sun rays, such that the portion of image that is visible when the napkin 110 is in the second condition illustrated in FIG. 6 is that of a sunrise or sunset along a horizon, with the horizon being the MD fold 126 (or optionally the CD fold 128) of the napkin 110.

The visual stimulation of seeing the portion of the image 112 on the quadrant 134 that was initially visible cooperate with the portion of the image 112 extending onto the quadrant 130 immediately upon unfolding the napkin 110 from the first condition, illustrated in FIG. 7, to the second condition, illustrated in FIG. 6, can further encourage the user to unfold the napkin 110 again, along the MD fold 126, revealing the remaining two quadrants 132, 136 of the napkin, as illustrated in FIG. 5, thereby bringing the entire image 112 into the user's view.

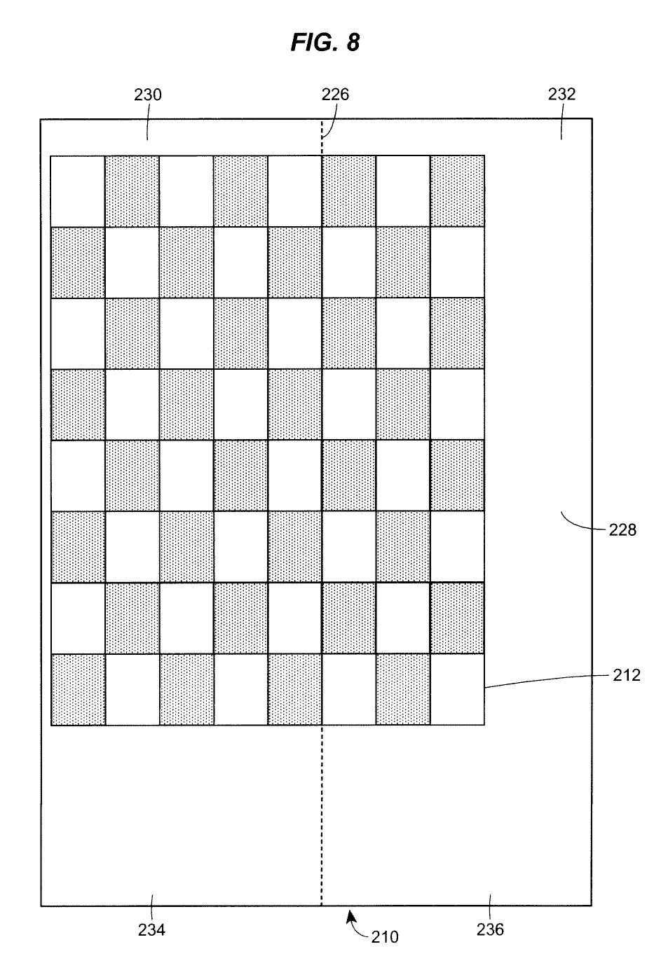

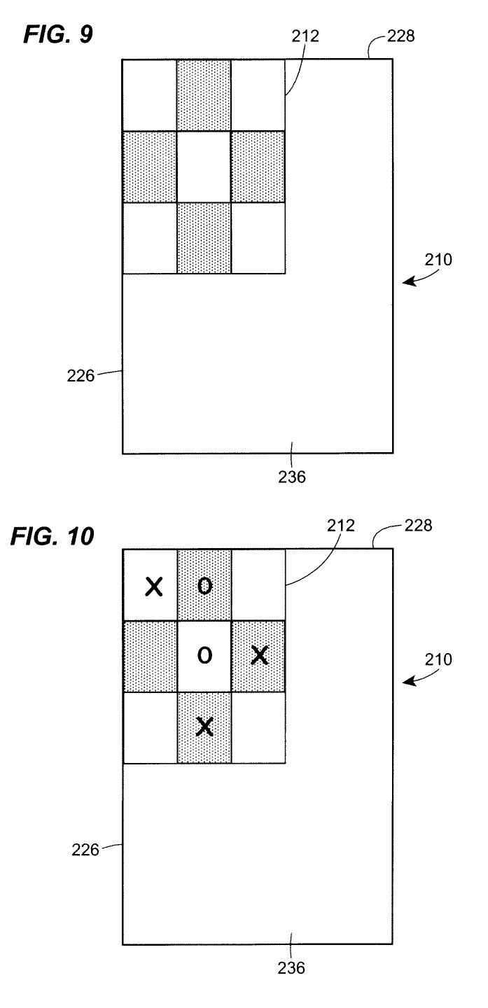

A third exemplary, but non-limiting, embodiment of a napkin 210 of the present disclosure is illustrated in FIGS. 8-10. As in the two embodiments described above, the napkin 210 includes an MD fold 226 and a CD fold 228, dividing the napkin 210 into four contiguous quadrants 230, 232, 234, 236. The napkin 210 includes an image 212 thereon. It should be realized that image 212 may be any image suitable for use with the present invention. Suitable images may include an image 212 that is symmetric or asymmetric about any of the MD fold 226, CD fold 228, and/or any intersection of the MD fold 226 and CD fold 228. A portion of the image 212 extends onto each of the four quadrants 230, 232, 234, 236. In this embodiment, the image 212 includes indicium or indicia that can encourage one or more users to interact with the napkin 2 10 by prompting the user to write or draw thereon. By way of example only, the image 212 may include a plurality of squares arranged in a grid pattern. As illustrated in FIG. 9, when the napkin 210 is folded both along the MD fold 226 and the CD fold 228 to its initial condition in which only one quadrant 236 is visible, the portion of the image 212 visible on the quadrant 236 is a 3-by-3 grid of squares. The 3-by-3 grid of squares appears to the user to be a complete image, reminiscent of or in the form of a tic-tac-toe board. As illustrated in FIG. 10, users are prompted by the graphics of the image 212 to actually play tic-tac-toe on the visible quadrant 236 of the napkin 210.

Upon twice unfolding the napkin 210 from the first condition as illustrated in FIG. 9 to a second condition as illustrated in FIG. 8, the entire image 212 is revealed. The entire image 212 may be that of a chess or checkerboard, i.e. an 8-by-8 grid of squares. Alternately, by way of example only, the entire image 212 may be in the form of a 9-by-9 grid of squares to form a Sudoku puzzle board. Thus, the image 212 provided on the napkin 210 may motivate the user to interact with the napkin by playing one or more logic or strategy games on the napkin.

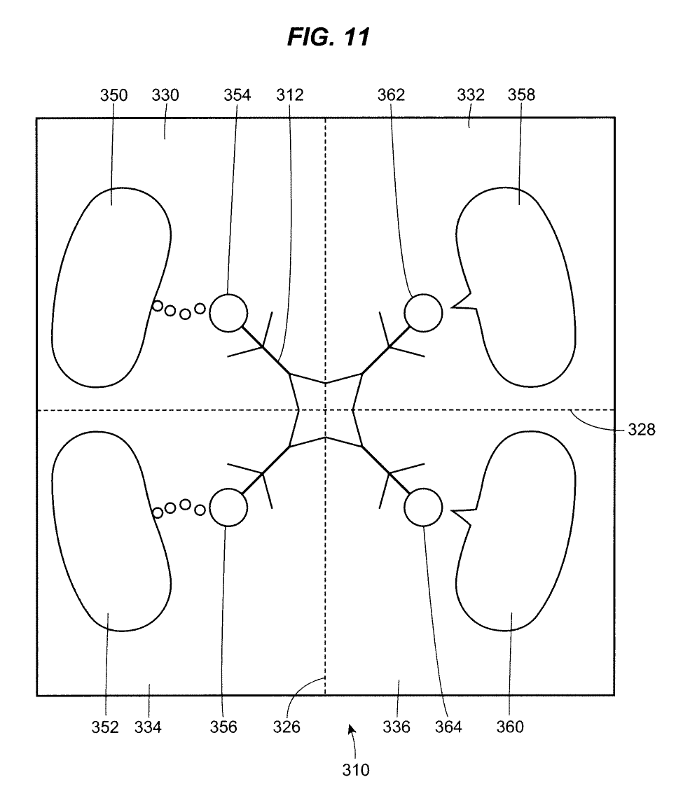

Alternatively or in addition, the image may motivate the user to interact creatively with the napkin. For example, with reference to FIGS. 11-14, a paper napkin 310 may be provided including an image 312 extending across two or more contiguous quadrants 330, 332, 334, 336 of the napkin 310. The image 312 may include “thought bubbles” 350, 352 extending from the heads of cartoon characters 354, 356, or “speech balloons” 358, 360 extending from the heads of cartoon characters 362, 364, prompting a user to write words inside the bubble or balloon. For non-limiting, illustrative purposes only, a thought or idea attributed to the character displayed on the image, or a portion of a conversation between characters may be depicted on the various quadrants of the napkin. The portion of the image 312 extending onto each quadrant 330, 332, 334, 336 or section of the napkin 310 may form a frame of a storyboard, such that the user writes the first thoughts or statements of one or more characters depicted on the first quadrant visible when the napkin is folded to its initial condition. With each unfolding of the napkin, as additional frames of the storyboard become visible, the user writes additional thoughts or statements of the characters depicted on the quadrants.

As may be appreciated with respect to FIGS. 8 and 11, the image 212 or 312 on the napkin 210 or 310 need not be symmetrically disposed across the various quadrants of the napkin 210, 310. Because an image such as image 212 or 312 need not be symmetrically disposed across the quadrants, the image 212 or 312 may be one for which intermediate views of contiguous quadrants appear differently depending upon the order in which the napkin 210 or 310 is folded and unfolded. For instance, it is preferable that the napkin 310 be folded first along the MD fold 326. However, depending upon the direction in which the napkin 310 is folded along the CD fold 328, the first quadrant visible may either be quadrant 336 or quadrant 330, if the folded napkin is presented with a particular face up, or may be either quadrant 334 or quadrant 332, if the folded napkin is presented with an opposite face up.

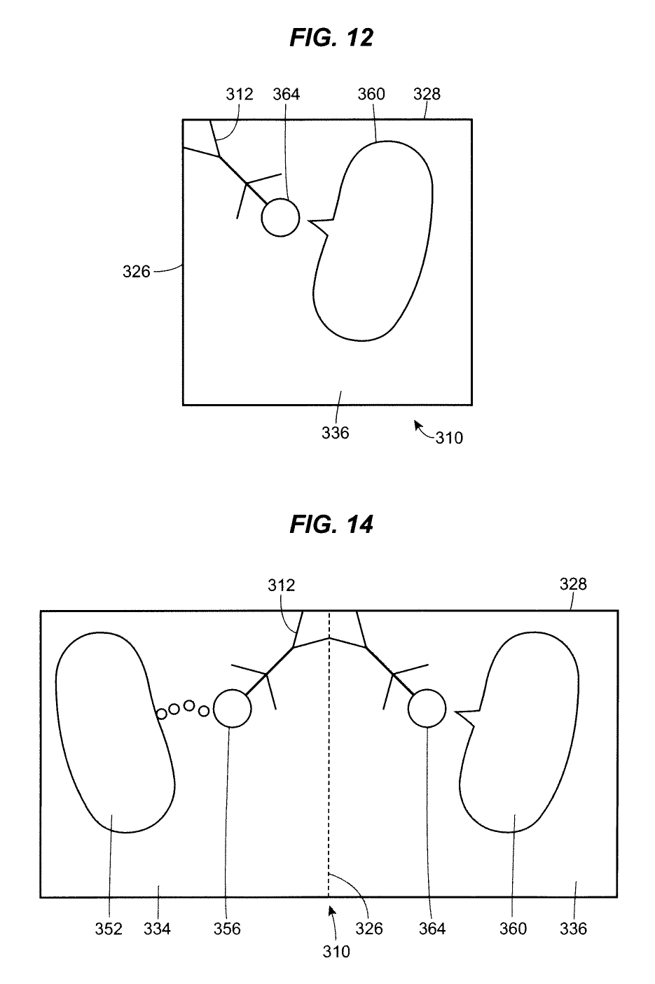

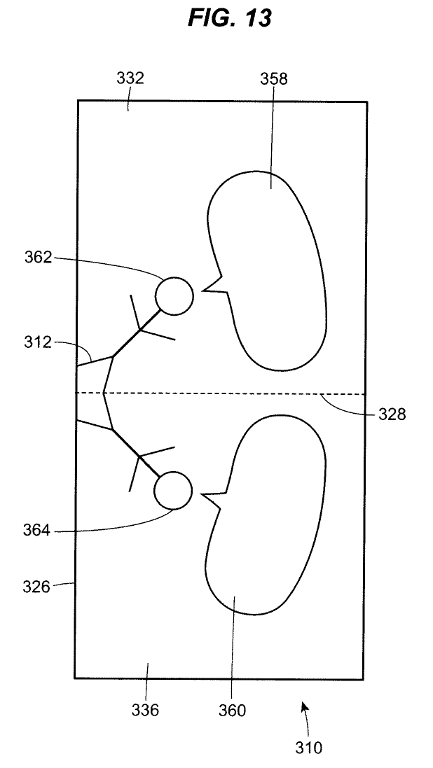

Assuming quadrant 336 is the first visible quadrant, as illustrated in FIG. 12, it is recognized that the napkin 310 may be folded in the preferred manner, i.e. first along the MD fold 326 and next along the CD fold 328, such that quadrant 332 is the second visible quadrant as the napkin 310 is unfolded, as illustrated in FIG. 13. Alternately, by folding the napkin 310 first along the CD fold 328 and next along the MD fold 326 so that quadrant 336 is the first visible quadrant, the napkin 310 may be folded such that quadrant 334 is the next visible quadrant as the napkin 310 is unfolded, as illustrated in FIG. 14. Thus, with an asymmetrical image 312, folding the napkin 310 in different orders can result in different intermediate images becoming visible upon successive unfolding of the napkin. By way of example only, the image 312 on the napkin 310 may depict a first character 364 on a first visible quadrant 336, a second character 362 on a second quadrant, and a third character 356 on a third quadrant, with each of the characters having at least one speech balloon 358, 360 or thought bubble 352 associated therewith. The napkin 310 may be folded in a first manner such that upon unfolding the napkin 310 from a first condition to a second condition, the first character 364 and the second character 362 appear to be having a conversation with one another. Alternately, the same napkin 310 may be folded in a second manner such that upon unfolding the napkin from the first condition to a second condition, as illustrated in FIG. 14, the first character 364 appears to be speaking to the third character 356, with the third character 356 having a thought as depicted in its associated thought bubble 352.

In all of the embodiments of the present disclosure, the napkin is a substrate having a first side and a second side, and which is foldable into a plurality of contiguous sections. The substrate has an image provided on at least one of the first side and the second side, and the image extends across at least two of the plurality of contiguous sections. The portion of the image which is visible on a first of the plurality of sections appears to be a complete image when the substrate is folded to a first condition and positioned so that the first of the plurality of sections of the substrate is visible and at least a second of the plurality of sections of the substrate is not visible.

Furthermore, when the substrate is unfolded from the first condition to a second condition in which both the first and second of the plurality of sections of the substrate are visible, the portion of the image on the first of the plurality of sections of the substrate, together with an additional portion of the image on a second of the plurality of sections of the substrate, appears to be a complete image.

The dimensions and values disclosed herein are not to be understood as being strictly limited to the exact numerical values recited. Instead, unless otherwise specified, each such dimension or value is intended to mean both the recited value and a functionally equivalent range surrounding that dimension or value. For example, a dimension disclosed as “40 mm” is intended to mean “about 40 mm.”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A substrate comprising:
a first side and a second side, the substrate being foldable into a plurality of contiguous sections;
an image provided on at least one of the first side and the second side, the image extending across at least two of the plurality of contiguous sections, and wherein a portion of the image provided on a first of the plurality of sections of the substrate appears to be a complete image when the substrate is folded into a first condition and positioned so that said first of the plurality of contiguous sections of the substrate is visible and at least one of the other sections of the substrate is not visible.

2. The substrate of claim 1 wherein the portion of the image on the first of the plurality of sections of the substrate, together with an additional portion of the image on a second of the plurality of contiguous sections of the substrate, appears to be a complete image when the substrate is unfolded from the first condition to a second condition in which both the first and second of the plurality of sections of the substrate are visible.

3. The substrate of claim 1 wherein the substrate is a napkin.

4. The substrate of claim 3 wherein the napkin is a paper napkin.

5. The substrate of claim 4 wherein at least one of the portions of the image prompts a user to write on the napkin.

6. The substrate of claim 5 wherein at least one of the portions of the image prompts a user to play at least one of a logic puzzle or a strategy game on the napkin.

7. The substrate of claim 5 wherein at least one of the portions of the image comprises at least one of a puzzle board or a game board.

8. The substrate of claim 5 wherein at least one of the portions of the image motivates a user to exercise creativity when writing on the napkin.

9. The substrate of claim 5 wherein at least one of the portions of the image includes at least one of a thought bubble or a speech balloon.

10. The substrate of claim 5 wherein each of the at least one thought bubble or speech balloon is associated with at least one character included in the image.

11. A paper napkin comprising:
a machine direction fold;
a cross-machine direction fold perpendicular and co-planar with the machine direction fold, the machine direction fold and the cross-machine direction fold dividing the napkin into four quadrants; and,
an image printed on at least one surface of the paper napkin, the image extending across at least two of the four quadrants, wherein a portion of the image on a first of the at least two quadrants appears to be a complete image when the napkin is folded to a first condition and positioned so that said first of the at least two quadrants is visible and at least one of the other four quadrants of the napkin is not visible.

12. The paper napkin of claim 11, and wherein the portion of the image on the first of the at least two quadrants, together with an additional portion of the image on a second of the at least two quadrants, appears to be a complete image when the substrate is unfolded from the first condition to a second condition in which both the first and second of the at least two quadrants are visible.

13. The paper napkin of claim 12, wherein the napkin includes a further fold extending from a point at which the machine direction fold and the cross-machine direction fold intersect to at least one corner of the napkin.

14. The paper napkin of claim 13, wherein the image includes a pair of intersecting diagonal lines extending between opposite corners of the napkin.

15. The paper napkin of claim 14 wherein one of the diagonal lines extends along the further fold extending from the point at which the machine direction fold and the cross direction fold intersect to at least one corner of the napkin, and a portion of the diagonal line extending along the further fold being visible when the napkin is folded along the machine direction fold, the cross direction fold, and along the further fold.

16. A napkin having a plurality of contiguous sections, and foldable into a first condition wherein one of the plurality of contiguous sections is visible and other of the contiguous sections are not visible, the napkin including means for motivating a user to unfold the napkin.

17. The napkin of claim 16 wherein the means for motivating the user to unfold the napkin includes an image extending across at least two of the plurality of contiguous sections, a portion of the image being visible when the napkin is in the first condition, said portion of the image appearing to be a complete image, and upon unfolding the napkin from the first condition to a second condition, revealing an additional portion of the image.

18. The napkin of claim 16, further including means for prompting a user to write on the napkin.

19. The napkin of claim 18, wherein the means for prompting the user to write on the napkin includes the image having indicia defining a region for a user to write thereon.

20. The napkin of claim 18, wherein the indicia includes at least one of a puzzle board, a game board, a thought bubble, or a speech balloon.
